(19) United States
(12) Patent Application Publication
(10) Pub. No.: US 2012/0078758 A1
(43) Pub. Date: Mar. 29, 2012

(54) BEHAVIOR EXCHANGE SYSTEM AND METHOD OF USE

(76) Inventor: GAIL R. MURPHY, MOUNT LAUREL, NJ (US)

(21) Appl. No.: 13/247,188

(22) Filed: Sep. 28, 2011

Related U.S. Application Data
(60) Provisional application No. 61/387,403, filed on Sep. 28, 2010.

(51) Int. Cl. G06Q 99/00; G06Q 30/00

(52) U.S. Cl. 705/27.2; 705/28

(57) ABSTRACT

An exchange system and method for exchanging positive behavior for items of monetary or social value. The exchange system uses databases that allow automated positive behavior point deposits to be uploaded into individual participant accounts and an interface that allows registered participants to see the value of the behavior points earned and deposited in individual accounts. The system uses an automated inventory management system of items for youth acquisition, an interactive interface displaying items available to participating youth and means of acquisition. The exchange system processes youth value exchange requests directly from the interface and maintains accounting of the transaction.

This application claims the benefit of Provisional Application Ser. No. 61/387,403 filed on Sep. 28, 2010, the contents of which are incorporated herein by reference.

### BACKGROUND OF THE INVENTION

1. Field of the Invention

The present invention is directed to a system and method for establishing and using an exchange market. In particular, the present invention is directed to a method and system directed towards promoting positive social behavior.

2. Description of the Related Technology

The world today places a greater value on establishing wealth than promoting social welfare. There are methods and markets that create an opportunity for individuals to increase their financial position by investing funds in exchange for ownership of underlying value, for example, stocks, bonds, commodities, and treasury bills. While these financial markets exist there are no similar markets for positive social behavior.

While all members of society agree that displays of positive social behavior are beneficial, much more emphasis is placed on increasing wealth than on increasing positive social behavior. By assigning a value to positive social behavior and allowing these values to be exchanged for new value, people will learn to desire and value acts of positive social behaviors. Therefore, there exists a need for a system and method for establishing a market for positive social behavior.

### SUMMARY OF THE INVENTION

An object of the present invention is a positive behavior exchange system.

Another object of the present invention is a method of using a positive behavior exchange system.

Still yet another object of the present invention is exchanging behavior points for inventory items.

Still yet another object of the present invention is establishing a behavior point exchange rate for inventory items.

An aspect of the present invention is a positive behavior exchange system comprising: a registration interface, an account database operably connected to the registration interface, wherein the account database stores youth accounts, wherein the youth accounts have stored therein behavior points, wherein the account database further stores inventory information; and an inventory management system operably connected to the account database, wherein the inventory management system provides the inventory information to the account database.

Another aspect of the present invention is a method of using a positive exchange system comprising: registering a youth organization at a registration interface; storing youth accounts from the youth organization on an account database operably connected to the registration interface, wherein behavior points are stored in the youth accounts; and storing inventory information in the account database, wherein the inventory information is received from an inventory management system operably connected to the account database.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which forms a further part hereof, and to the accompanying descriptive matter, in which there is illustrated and described a preferred embodiment of the invention.

### BRIEF DESCRIPTION OF THE DRAWINGS

FIG. 1 is a diagram of the system employed in the present invention.

FIG. 2 is a flow chart showing the method of how the youth organization uses the exchange system.

FIG. 3 is a flow chart showing the method of how the exchange system establishes the point values.

FIG. 4 is a flow chart of a method used in employing the system.

### DETAILED DESCRIPTION OF THE PREFERRED EMBODIMENT(S)

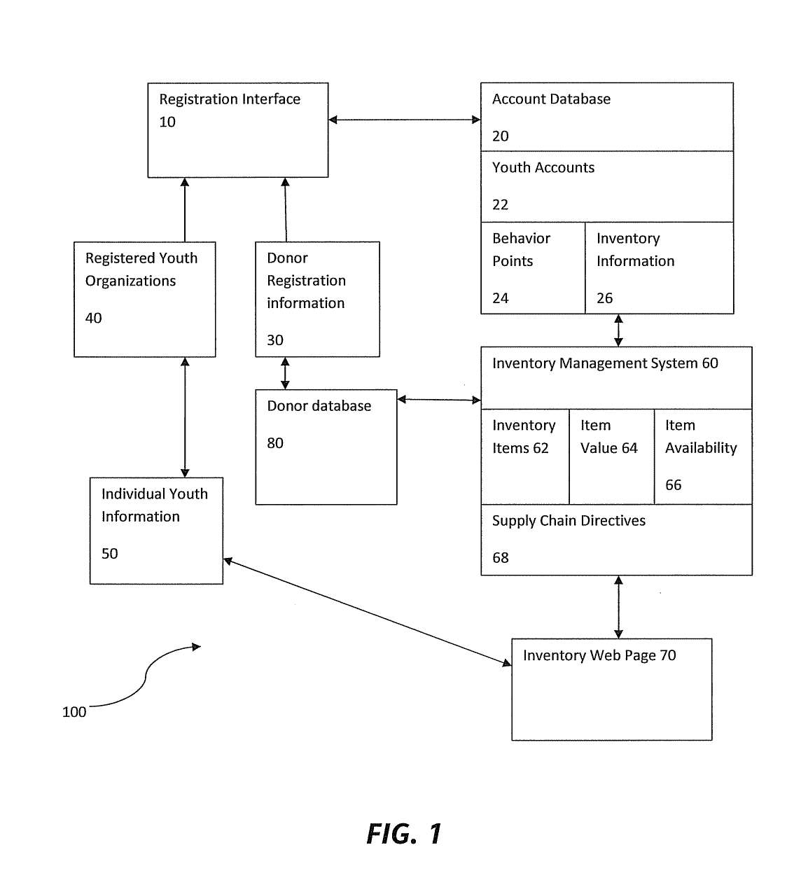

FIG. 1 shows a diagram of the positive behavior exchange system 100. It should be understood that the modules and components employed in the exchange system 100 may be represented and hosted on various software, hardware, mobile and network based systems. While reference may be made to individual components, it should be understood that additional components may be used in order to complement or enhance the performance of the system.

The exchange system 100 comprises a registration interface 10 and an account database 20 operably connected to the registration interface 10. The account database 20 may be a server that stores the data and is able to be accessed via an online network. The registration interface 10 permits access for youth organizations 40 and the individual youth information 50 provided controlled by the youth organizations, to be registered and stored on the account database 20. Youths are typically those under the age of 18 and/or those involved in schooling.

Donors may also provide their donor registration information 30 to the registration interface 10 to be registered and stored at the account database 20. Donors may be individuals, organizations, or companies that donate inventory items or money in order to provide the inventory available for the exchange system 100. The term “donors” may also encompass those companies or individuals that provide merchandise or services for money at bulk prices, at a discount or in full.

The account database 20 contains individual youth accounts 22, data from the registered youth organizations and data from the donors. The youth accounts 22 contain behavior points 24 that represent tasks performed or other various accomplishments. The account database 20 additionally comprises inventory information 26.

Behavior points 24 and information related to the behavior points 24 are uploaded from registered youth organizations 40 on a regular basis, and then deposited into the youth accounts 22. Behavior point values and the exchange rate for an inventory item 62 may be established by either the donor, the registered youth organization 40, and/or a combination of both. Furthermore, the point values awarded to a behavior may be established by either the donor, the registered youth organization 40 and/or a combination of both.

The exchange system 100 further receives data from the inventory management system 60. The inventory management system 60 provides inventory items 62, item value 64, item availability 66, and supply chain directives 68.

The inventory management system 60 may further display on an inventory web page 70 the items' properties. Additional information that may be provided regarding the inventory item 62 may be how to obtain it, photos of it, donor information, and the capability to display extensive donor information, including photos, videos, social media connections, links and other related information at such times. Participant using the exchange system 100 may review the displayed items that are on the inventory management system 60 when desired. Behavior points 24 accumulated in the youth accounts 22 may be exchanged for inventory items 62. The exchange system 100 will then trigger an automated review process to ensure that there are sufficient behavior points 24, and the inventory item 62 is still available. Upon completion of the monitoring and oversight aspect of the automated procedure, the transaction will complete and the behavior points 24 will be deducted from the youth account 22. The automated inventory process will signal the removal of the item from the inventory web page 70.

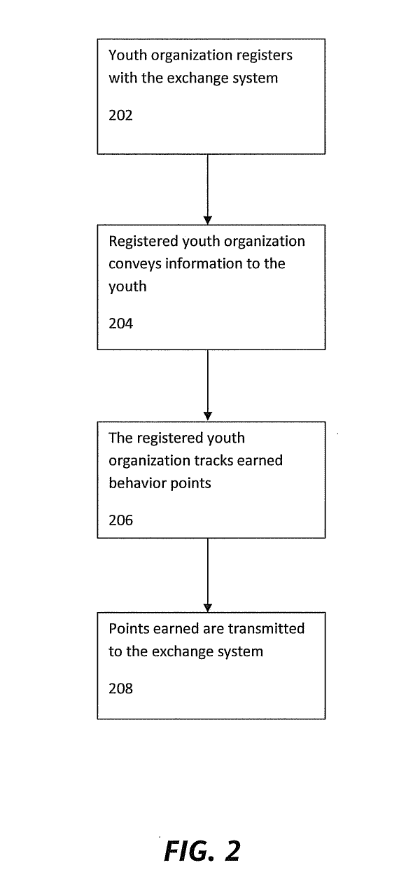

FIG. 2 is a flow chart showing the method of how the registered youth organization 40 uses the exchange system 100. In step 202, a youth organization registers to become a registered youth organization 40 on the exchange system 100. The registered youth organization 40 will register each youth attending with the exchange system 100.

In step 204, the registered youth organization 40 conveys the information to the youth as to what behaviors merit reward and the behavior points 24 awarded for each task or behavior. This information may be conveyed directly to the youth via their exchange system youth accounts 22.

Typically, the behaviors recognized and rewarded are those that will result in a decrease in violence, bullying, and other anti-social behaviors. The organization will award students points for displays of the identified positive behaviors, which may include but not be limited to empathy, inclusion, tolerance, respect, uniqueness, individual talent and community service.

Behavior points 24 may be established and used in the following manner. Potential donors may include businesses, individuals, schools, and students. Donors may be organized by its “Market Sector.” For each Market Sector the positive social behaviors may be identified and established, by either the donor, the youth organization and/or the exchange system and may be particular to that donor, youth organization and/or exchange system. For example, tutoring services, clean up services, and other outreach programs, or programs for including others, anti-bullying programs and anti-violence programs may be either the focus of the programs or one of many possible programs. For each Market Sector the number of behavior points 24 to be assigned for each performance of the positive social behaviors may be provided. The donors may be provided with credit in the form of exchanges with participating entities in other Market Sectors and may take the form of written, electronic, and or other forms of advertising, public relations, marketing or other types of promotional opportunities for the donors in exchange for donated items and/or services. The exchange system 100 may further require that some evidence be provided by the registered youth organization 40, such as video, or other types of recorded information in order to demonstrate that a particular behavior was performed or a task was completed.

In step 206, the registered youth organization 40 tracks the amount of behavior points 24 that each youth earns. In step 208, the registered youth organization 40 may then enter the behavior point total and transmit the behavior point total to the account database 20 on the exchange system 100.

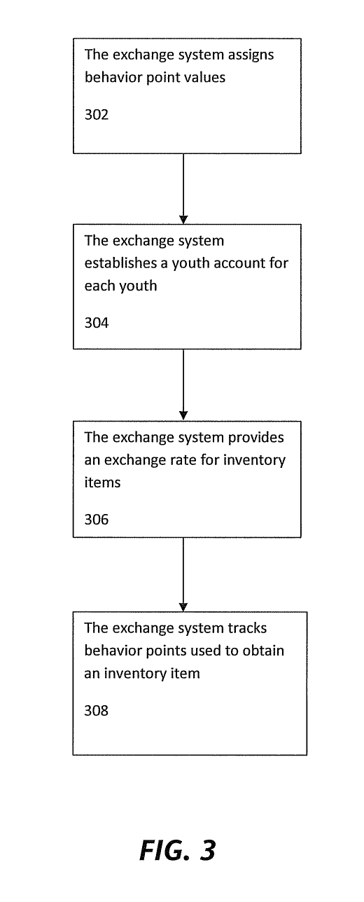

FIG. 3 is a chart showing the method of how the exchange system 100 tracks values of the behavior points 22. At step 302, the exchange system 100 assigns values for preferred behaviors and tasks and identifies the positive behaviors that the registered youth organizations 40 will teach and track.

At step 304, the exchange system 100 establishes a youth account 22 for each youth. At step 306, the exchange system 100 provides information and data regarding the inventory items 62 that will be available for youth to obtain with their earned points. In step 306, the exchange system 100 provides an exchange rate for the inventory items 62. These inventory items 62 may be provided a behavior point value based on its monetary and social value as compared to other available items, and the economic value of the inventory items 62 as a whole. In step 308, the system tracks the behavior points 24 used to obtain the requested item, and deducts its value from the individual youth account 22.

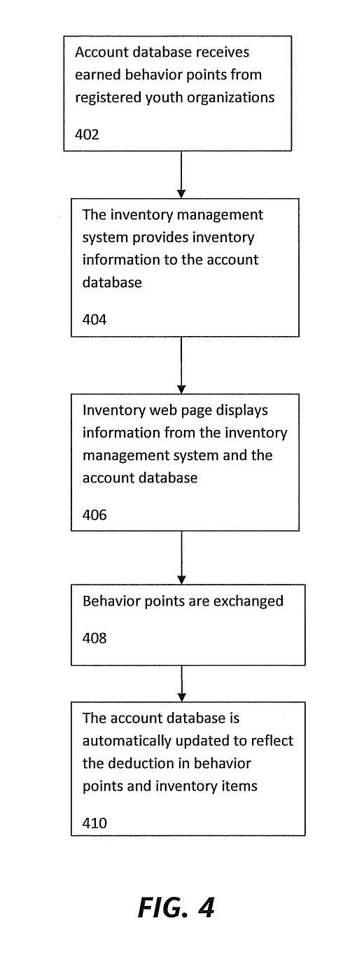

FIG. 4 is flow chart showing the use of the exchange system 100. It should be understood that the steps discussed herein need not be performed in the order discussed. In step 402, the account database 20 receives from the youth registered organizations 40 the individual youth information 50 and the behavior points 24 earned by the youth. This information may be entered via the registration interface 10.

In step 404, the inventory management system 60 provides inventory information 26 to the account database 20. Supply chain directives 68, item value 64 and item availability and inventory items 62 are maintained, tracked and updated from a donor database 80. To automate, track and provide supply chain functionality, there is an inventory management system which feeds from the donor database 80.

In step 406, the inventory web page 70 displays information from the inventory management system 60, as well as information received from the account database 20.

In step 408, behavior points 24 are exchanged for the inventory item 62. In step 410, the account database 20 is automatically updated to reflect the deduction in behavior points 24 and the inventory items 62.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A positive behavior exchange system comprising:
a registration interface,
an account database operably connected to the registration interface, wherein the account database stores youth accounts, wherein the youth accounts have stored therein behavior points, wherein the account database further stores inventory information; and
an inventory management system operably connected to the account database, wherein the inventory management system provides the inventory information to the account database.

2. The exchange system of claim 1, further comprising an inventory web page, wherein the inventory web page displays inventory items, value of the inventory item in behavior points and the inventory item availability.

3. The exchange system of claim 1, further comprising a donor database operably connected to the inventory management system.

4. The exchange system of claim 1, wherein the account database further stores donor registration information and registered youth organization information.

5. The exchange system of claim 4, wherein the inventory information comprises a behavior point value of an inventory item.

6. The exchange system of claim 5, wherein the donor registration information comprises the behavior point value established by the donor.

7. The exchange system of claim 5, wherein the registered youth organization information comprises the behavior point value established by the youth organization.

8. The exchange system of claim 1, wherein the inventory management system further comprises supply chain directives received from the donor database.

9. The exchange system of claim 1, wherein the behavior points are based on anti-bullying behavior.

10. The exchange system of claim 1, further comprising an inventory web page, wherein the inventory web page displays inventory items with donor information, photos, videos, social media connections and links.

11. A method of using a positive exchange system comprising:
registering a youth organization at a registration interface;
storing youth accounts from the youth organization on an account database operably connected to the registration interface, wherein behavior points are stored in the youth accounts; and
storing inventory information in the account database, wherein the inventory information is received from an inventory management system operably connected to the account database.

12. The method of claim 11, further comprising displaying an inventory web page comprising inventory items, value of the inventory item in behavior points and the inventory item availability.

13. The method of claim 11, further comprising transmitting inventory data from a donor database to the inventory management system.

14. The method of claim 11, further comprising storing donor registration information and registered youth organization information in the account database.

15. The method of claim 14, wherein the inventory information comprises a behavior point value of an inventory item.

16. The method of claim 15, wherein the donor registration information comprises the behavior point value established by the donor.

17. The method of claim 15, wherein the registered youth organization information comprises the behavior point value established by the youth organization.

18. The method of claim 11, transmitting supply chain directives from the donor database to the inventory management system.

19. The method of claim 11, wherein the behavior points are based on anti-bullying behavior.

20. The method of claim 11, further comprising displaying inventory items with donor information, photos, videos, social media connections and links on the inventory web page.
